(19) United States
(12) Patent Application Publication
(10) Pub. No.: US 2003/0014357 A1
(43) Pub. Date: Jan. 16, 2003

(54) Method and system for conducting user defined mobile commerce

(75) Inventors: John Chrisekos, Concord, CA (US); Teck T. Heng, Singapore (SG)

Correspondence Address: General Motors Corporation, Legal Staff Mail Code 482-C23-B21, 300 Renaissance Center, P.O. Box 300, Detroit, MI, 48265-3000, US

(73) Assignee: General Motors Corporation

(21) Appl. No.: 09/906,488

(22) Filed: Jul. 16, 2001

(51) Int. Cl. G06F 17/60

(52) U.S. Cl. 705/39

(57) ABSTRACT

The invention provides a method for conducting user defined mobile commerce by receiving a customer ID and a transaction information from a transaction provider. The method further accesses a customer defined mobile commerce transaction account corresponding to the customer ID. At least a portion of the transaction information is compared with the customer defined mobile commerce transaction account information; and a transaction status is determined based on the comparison of the transaction information and the customer defined mobile commerce transaction account information.

### FIELD OF THE INVENTION

In general, the invention relates to the field of communication systems. More specifically, the invention relates to mobile commerce communications and in particular, to transmitting and receiving devices in wireless communication with proprietary financial institutions.

### BACKGROUND OF THE INVENTION

Database marketers have contributed significantly to the universal corporate goals of acquiring, retaining, and growing the value of a company's customers. Today, it is routine for firms to use customer transaction data to construct retail trade areas and consumer behavior profiles for the purpose of acquiring new customers. Retention programs, enhanced by modeling, are proactive and can be aimed directly at customers who show a propensity for leaving the company, as opposed to reacting to customers who are long gone. Growth targets for existing customers are established, using real purchase data to spot potential up-sell and cross-sell opportunities.

The most critical step for database marketers, and for the measured marketing process, is to construct a strategy for linking point-of-sale transactions to the individual customer conducting the transaction. The large assortment of electronic payment media available is making it easier to close the loop between customers, sales, and stores. Proprietary and third party credit cards, frequency programs, and stored value cards are continuing to provide a key link.

Many leading firms are adopting new and unique ways to bridge the prior mentioned loop. Mobile or cellular phone technology is now capable of accessing e-commerce Internet sites in order to conduct consumer transactions. These phone systems however are expensive, and some consumers might prefer a simpler, less expensive alternative for mobile commerce.

Another of the more interesting methods in use today is Mobil Oil's Speedpass. This technology uses radio or “transponder” frequencies in the same manner as many tollways do to speed up the toll collection process. Customers register with Mobil and indicate their preferred payment method (e.g. Visa, MasterCard, Mobil Card, etc.). To activate the pump dispenser, customers “wave” the key chain Speedpass device in front of the pump, and their transaction is authorized and recorded. This saves time at the pump for Mobil's customers, and provides Mobil with a valuable database of transactions regardless of a customer's preferred electronic media payment method. A problem arises however, if the customer wishes to use the device for alternative business purposes. Automatic toll and payment collection systems, including Mobil Speedpass, only work for the retail system that they were engineered compliant. In addition, once programmed with the customer information, the transponder devices cannot be updated or data maintained without being returned to the issuer.

Another innovation is the use of “Smart cards”, a small electronic device about the size of a credit card that contains electronic memory, and possibly an embedded integrated circuit (IC). Smart cards containing an IC are sometimes called Integrated Circuit Cards (ICCs). Smart cards are used for a variety of purposes, including storing a patient's medical records, storing digital cash, and generating network IDs (similar to a token). To use a smart card, to either pull information from it or add data to it, you need a smart card reader for contact smart cards. Contact smart cards have contacts to the semiconductor chip on the surface of the card in compliance with ISO Standard 7816. For contactless smart cards, with no contacts on the surface of the card, connection with the semiconductor is done by means of radio frequency transmission through the surface of the card. Regardless of which smart card type, smart cards often require users to download money into the card prior to transactions, making them more difficult and inconvenient to use. In addition, smart card purchasing parameters in memory can only be edited by the issuing agency. Further, all of the above mentioned devices require additional information output devices such as printers or monitors in order to view the transaction information prior to its confirmation or to confirm that the embedded data correlates with the customers records.

Therefore, it would be desirable to have a method for conducting a user definable mobile commerce that provides adequate transaction information, a secure transaction interface, multiple payment options, and an interactive medium for user customization. Further, it would be desirable that the improved method for conducting mobile commerce provide for the complexities and problems associated with all of the above-mentioned devices.

### SUMMARY OF THE INVENTION

One aspect of the invention provides a method for conducting user defined mobile commerce by receiving a customer ID and a transaction information from a transaction provider. The method further accesses a customer defined mobile commerce transaction account corresponding to the customer ID. At least a portion of the transaction information is compared with the customer defined mobile commerce transaction account information; and a transaction status is determined based on the comparison of the transaction information and the customer defined mobile commerce transaction account information.

Another aspect of the invention provides a system for conducting user defined mobile commerce with means for receiving a customer ID and a transaction information from a transaction provider. Next, a means for accessing a customer defined mobile commerce transaction account corresponding to the customer ID is provided. Additionally the system provides a means for comparing at least a portion of the transaction information with the customer defined mobile commerce transaction account information, and finally, means for determining a transaction status based on the comparison of the transaction information and the customer defined mobile commerce transaction account information are also included.

A further aspect of the invention provides a computer readable medium storing a computer program with computer readable code for receiving a customer ID and a transaction information from a transaction provider. The computer readable medium is further provided computer readable code for accessing a customer defined mobile commerce transaction account corresponding to the customer ID. Also provided is computer readable code for comparing at least a portion of the transaction information with the customer defined mobile commerce transaction account information. Additionally, the computer readable medium is provided computer readable code for determining a transaction status based on the comparison of the transaction information and the customer defined mobile commerce transaction account information.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a diagram of one embodiment of a communication system in accordance with the invention;

FIG. 2 is a flow-chart diagram of one embodiment of a method for a mobile commerce system, in accordance with the invention;

FIG. 3 is a diagram of a method of one embodiment of application for the communication system of FIG. 1, in accordance with the invention;

FIG. 4 is a diagram of a method of one embodiment of payment for the communication system of FIG. 1, in accordance with the invention; and

FIG. 5 is a diagram of a method of one embodiment of security for the communication system of FIG. 1, in accordance with the invention.

### DETAILED DESCRIPTION OF A PREFERRED EMBODIMENT

All embodiments of the invention may use a network for interactive communications. One embodiment may use the Internet as its method of network communications; however, any other network method known in the art may also be used in part or in whole. One embodiment may also utilize computer programs and computer programming. Additionally, embodiments of the invention may use computer hardware capable of storing, writing, reading, editing, and processing computer programs.

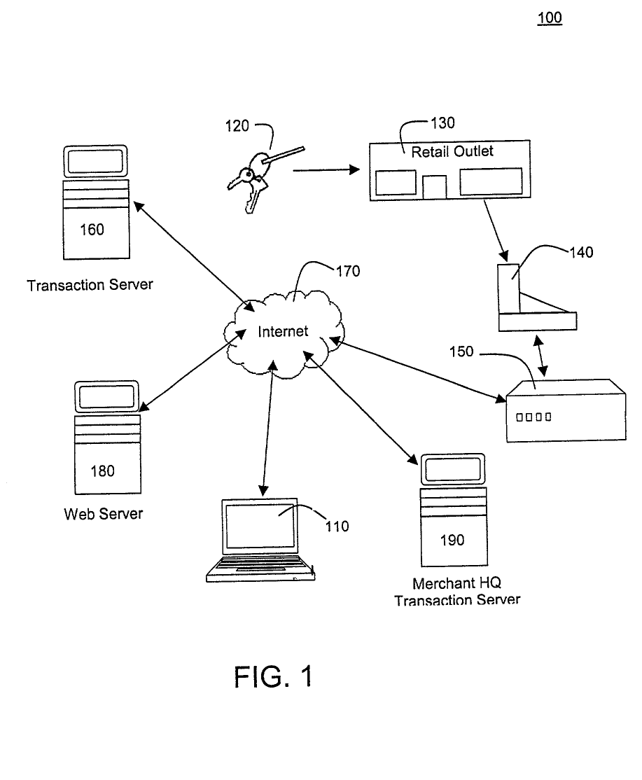

One embodiment of the invention, as illustrated in FIG. 1, provides a system 100 for mobile commerce transactions. The mobile commerce system (system) 100 may contain a user device 110 capable of accessing and editing information via an Internet 170 connection. The user device 110 may be a handheld personal digital assistant (PDA), a laptop computer, a personal computer (PC), a mobile telephone, or any other computer hardware and software device with editing and internet connection capabilities.

The user device 110 can be used to edit a customer defined mobile commerce transaction account. The customer defined mobile commerce transaction account may be kept on a transaction server 160 in communication with the Internet 170. The transaction server 160 may be in communication with a customer (user) interface (websites and web pages) held on a web server 180, also in communication with the Internet 170. The customer interface may help users to conduct a variety of administrative tasks of the customer defined mobile commerce transaction account, such as monitoring the users transaction history, report loss of equipment, setting spending limits on the account, etc. The editable information may include, but is not limited to, personal user identifiers such as the users name and address, credit card information, banking account information, or self imposed credit limits on accessible accounts.

In one embodiment, the transaction server 160 may be in communication with, or managed by, a financial institution or credit-authorizing agency, or it may be for an alternative organization or financial transaction system capable of providing user credit information and authorization for purchases. Additionally in one embodiment, the transaction server 160 can record and maintain a record of each transaction made by its customers.

The user information may further be accessed with the aid of a wireless transponder device 120 in the form of a key fob or other handheld device, a car tag attached to some part of a car, or any other form capable of providing a predefined customer ID signal. The transponder device 120 can also be integrated with other systems, e.g. car entry systems in an automobile, for a further extension of functionality. Additional embodiments may allow for customer ID information to be contained within a device to be accessed or “read” by an external device such as a credit card and card reader without using transponder technology. Furthermore, an embodiment of the invention allows individual customers to have and manage more than one transponder device 120 (each with its own customer ID) on one customer defined mobile commerce transaction account.

The transponder device 120 may be in communication with a transaction provider (retailer) 130 equipped capable of accessing or receiving the customer ID information. The transaction provider 130 may be a retail outlet or other business, a consumer services provider such as for cable TV, Internet, or phone service, or any other commercial entity in accordance with the invention. For one embodiment, the transaction provider 130 is provided a compatible reader for the transponders 120 from a transaction service provider and ‘signs on’ to a transaction service provided through a transaction server 160. One embodiment of the invention may define any provider of a mobile commerce system in accordance with the invention as a transaction service provider. The transaction provider 130 can obtain the transponder reader 120 by registering for a mobile commerce transaction account with the transaction service.

The transaction provider 130 may supply along with the application their intent for use of the mobile commerce system 100, and upon acceptance and if applicable, may load proprietary software onto the transaction providers 130 point of sale equipment for communicating with the transaction server 160, and the web server 180, through the Internet 170. The point of sale equipment for one embodiment may include a cash register 140 that may be in communication with an Internet accessible device 150, for example a modem or network card. Additional embodiments may provide that the device 150 include transmitting and receiving (transceiver) capabilities. In one embodiment, the transaction providers may be in contact with their corporate transaction server (merchant HQ) 190 through the Internet 170 or other network connectivity known to the art. An additional embodiment can allow for a transaction amount on the cash register 140 to be passed to the modem 150 along with a customer ID received from a transponder 120. The modem 150 may access the transaction server 160 through the Internet 170 and pass along the user ID, as well as the transaction information, and any additional pertinent information for the retailer 130. Dependent on the customer defined mobile commerce transaction account information; the transaction server 160 may provide an authorization for the transaction to be completed. If authorized, the transaction authorization may be passed through the Internet 170 in order to provide the information to the modem 150, and finally to the cash register 140 so the transaction can be completed.

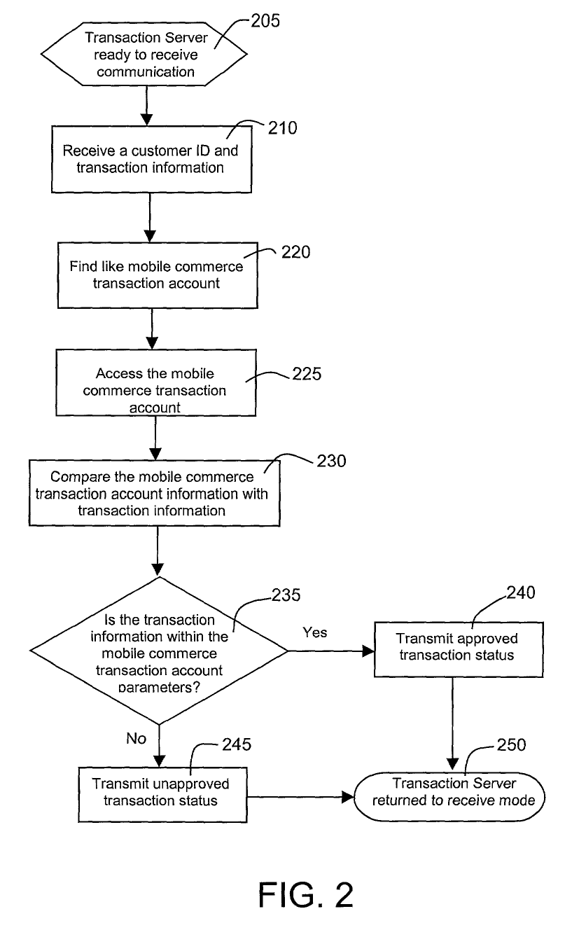

Additional embodiments may add, delete, or exchange the above-mentioned system 100 items while still providing a similar service. A flow chart diagram of a transaction service providing a mobile commerce system is illustrated in FIG. 2.

One embodiment of a mobile commerce system begins with a transaction server ready to receive a request 205. One embodiment of a transaction request may contain part or all of a submitted transaction as well as the customer ID. Upon receiving a transaction request from a transaction provider 210, the transaction server may use the customer ID to cross-reference with a corresponding mobile commerce transaction account 220. The transaction server may access the mobile commerce transaction account 225 in order to compare the pertinent transaction information with the customers defined mobile commerce transaction account information 230. In one embodiment, the transaction server may be required to initiate communication with a web server in order to access the mobile commerce transaction account. The web server can host and maintain the mobile commerce transaction accounts for that embodiment and distinct information may need to be requested by the transaction server. If the mobile commerce transaction account information and the transaction providers transaction information are congruent 235, the transaction server may transmit a transaction status stating approval to the transaction provider 240, else a transaction status stating disapproval will be processed 245. Alternative embodiments may require the transaction server to transmit the transaction status to locations other then the originating transaction provider. Afterward the transaction server may return to a mode ready to receive the next request 250.

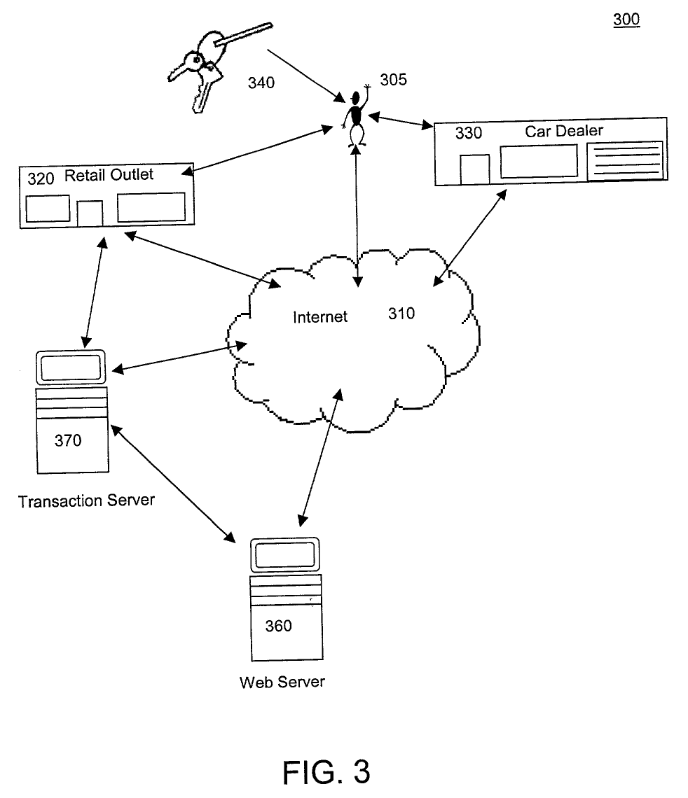

Another embodiment of the invention provides a system 300, illustrated in FIG. 3, for registering for a mobile commerce transaction account with a transaction service, in order to participate within a mobile commerce transaction system. Applicants for registration (customers) 305 can use multiple channels for providing an application. One embodiment can provide registration channels including the Internet 310, car dealerships 330, and retail outlets 320. In the embodiment using the Internet 310 for registration, the customer 305 can use any means known in the art to access a designated Internet address to view and complete a mobile commerce transaction system registration application. The customer 305 applying for registration to use the mobile commerce transaction system may be required to provide various personal information including a completed customer profile questionnaire, specifying the number of transponder devices 340 required, and assigning payment methods and spending limits for each transponder device 340. For one embodiment, payment methods can include credit cards, debit cards, check payments, or other options for short-term loan repayment known in the art.

In one embodiment, after an application has been filled out by the customer 305, the application can be sent to and processed by a transaction server 370 via the Internet 310. The transaction server 370 may contain software, hardware, and connectivity required to process the customer 305 applications. An additional embodiment illustrated in FIG. 3, can use a web server 360 for processing applications. Still another embodiment may require the use of both the transaction server 370, and the web server 360.

Once processed and approved, the customer 305 can be sent (or possibly handed) a transponder device 340 coded for their specific use. Another embodiment provides the customer 305 with WebPages accessible by the Internet 310, which may be maintained on the web server 360. These WebPages may allow the customer 305 to personalize his/her web page and to request information such as transaction statements. Additionally, the customer may use the WebPages to adjust spending limits for each transponder device 340 assigned them, access special promotions form retailers, report lost transponders 340, or other information provided for customer service. A further embodiment may require that the customer 305 maintain a minimum cash balance within an account prior to being assigned a transponder device 340, and in order to keep the transponder device 340 activated.

Once a transponder device 340 has been issued and activated, transactions can then be carried out. When the customer 305 makes a transaction within a participating retail outlet 320, the transaction information is sent to a transaction server 370 for processing and authorization. Upon processing of the transaction, the transaction server 370 can transmit back to the retail outlet its decision. In one embodiment, the transaction information is also sent from the transaction server 370 to the web server 360 via the Internet 310, to be recorded and displayed on the customers web pages.

A further embodiment may allow a retail outlet 320 or other business entity, to access specified customer information maintained on the web server 360, which may be used for target marketing. Additionally, the retail outlet 320 may be provided access to place specific ads on the customers 305 web pages.

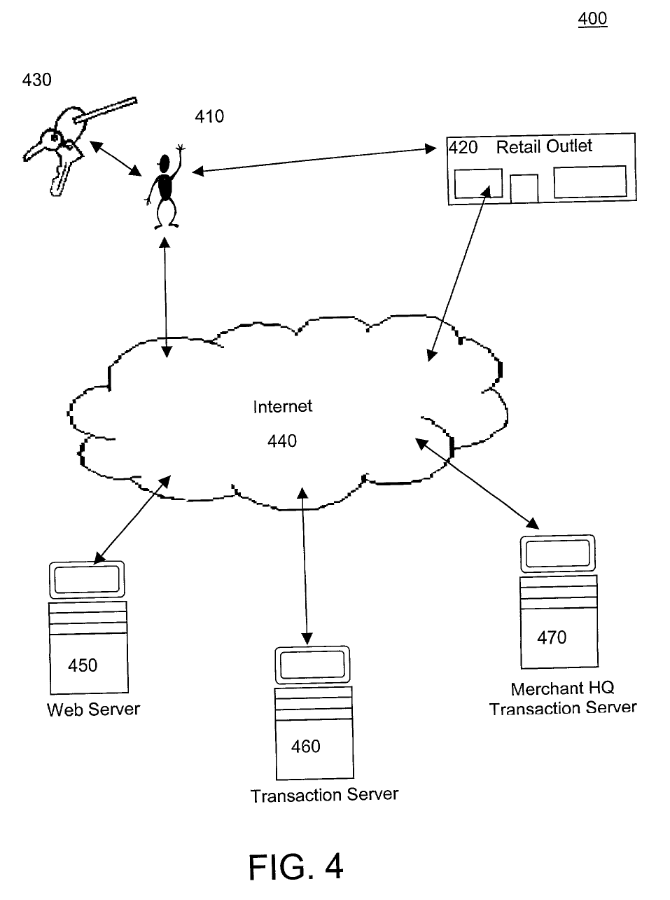

Illustrated in FIG. 4 is an embodiment of the invention, which provides a method 400 for performing a transaction and providing a transaction payment. The method 400 begins when a customer 410, using an assigned transponder device 430, requests a transaction at a business. For the embodiment of FIG. 4, a retail purchase can be made from a retail outlet 420. The retail outlet 420, having a transmitting/receiving device suitable for use with the invention, may transmit a request for a transponders customer ID number. Another embodiment may receive a constantly transmitted customer ID number from the customers transponder device 430. Additionally, another embodiment provides transmitting to the transponder device 430, and/or being provided the transponder devices 430 ID, by any other method known in the art.

Once a transponder ID number has been received by the retail outlet 420, the retail outlet 420 can transmit the transaction information and transponder ID to a transaction server 460 controlled by a transaction service, through the Internet 440. One embodiment of the transaction server 460 may keep a record of the information, while another embodiment of the invention provides that the transaction server 460 may check the customer 410 balances within a financial account associated with the transaction server 460. If an embodiment requiring an account balance finds adequate monies within the account to cover the proposed transaction, the transaction server 460 may contact the retail outlet 420 headquarters (HQ) transaction server 470 through the Internet 440, and provide payment to the HQ transaction server 470 from the customers financial account. With payment complete, the HQ transaction server 470 may contact the retail outlet via the Internet 440, and transmit an approval (or transaction status) for the transaction to proceed. If the transaction server 460 of one embodiment had found insufficient funds within the customer account, the transaction server 460 may provide the retail outlet 420 with an unapproved transmission, ending the process. Other embodiments of the invention may provide alternative methods of payment, allowing the transaction to complete as approved.

With the transaction approved or not approved, an embodiment of the invention can provide a network link between the transaction server 460 and a web server 450 via the Internet 440. The transaction server 460 may provide updated customer information to the customer 410 account web pages hosted by the web server 450. In one embodiment, the customers 410 user account web pages can allow the customer 410 to check statements, adjust maximum spending levels, change payment methods, increase spending limits for multiple transponders assigned to their account, or any other customer service allowing customer interaction.

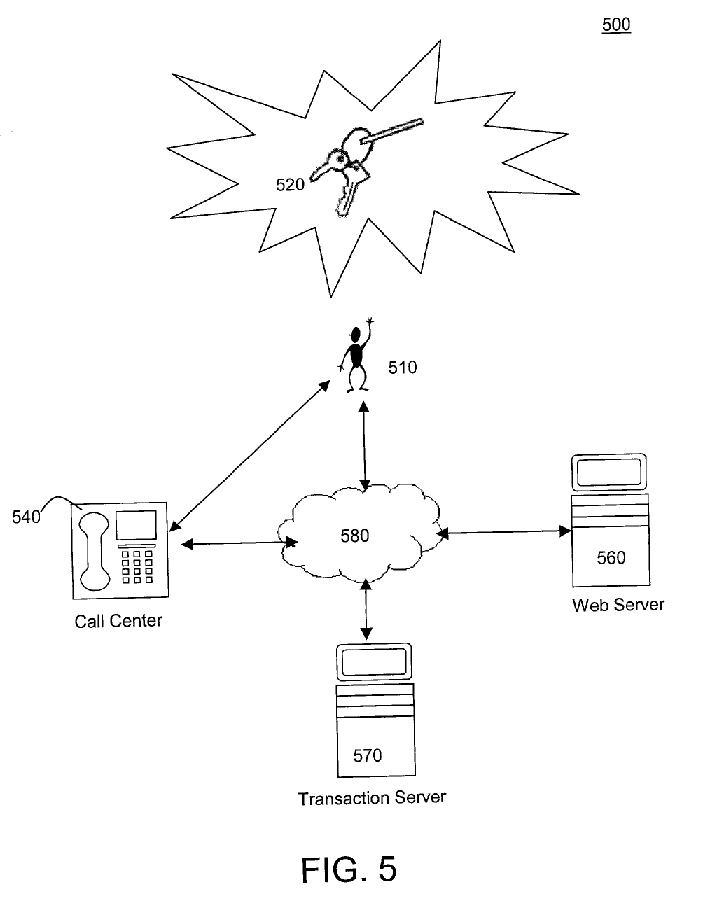

A further embodiment of the invention, illustrated in FIG. 5, can provide a method 500 of reporting a lost or damaged transponder device 520. If the customer 510 losses their transponder 520 or has the transponder stolen, for one embodiment the customer 510 may report the incident to a web server 560. In another embodiment, the customer 510 may use a typical phone system and contact a call center 540 in accordance with the invention. For one embodiment, reporting the incident through the web server 560 can automatically set the spending limit for the reported transponder account to $0. If the transponder is used again, an alert, together with information on the time and location of use, can be sent to a policing agency for immediate action. The web server 560 may also contact a transaction server 570 to provide financial institutions within the scope of the invention, with the incident information and updated account information.

For an embodiment reporting a loss or theft incident using the call center 540, the call center 540 (either automatically or manually) may contact the transaction server 570 and provide the incident information, and may update the customers account information. For the embodiment of FIG. 5, contact may be made over an Internet connection 580; however, any form of interaction with a network device known in the art may be used alternatively. A further embodiment may provide that the transaction server 570 or the call center 540 provide the updated information to the web server 560.

The present invention may be embodied in other specific forms without departing from its spirit or essential characteristics. The described embodiments are to be considered in all respects only as illustrative and not restrictive.

We claim:

1. A method for conducting user defined mobile commerce comprising:
receiving a customer ID and a transaction information from a transaction provider;
accessing a customer defined mobile commerce transaction account corresponding to the customer ID;
comparing at least a portion of the transaction information with the customer defined mobile commerce transaction account information; and
determining a transaction status based on the comparison of the transaction information and the customer defined mobile commerce transaction account information.

2. The method of claim 1 further comprising:
receiving a transaction provider application for a business mobile commerce transaction account; and
determining a transaction provider approval status based on the transaction provider application.

3. The method of claim 1 further comprising:
providing a transceiver device to a transaction provider.

4. The method of claim 1 further comprising:
receiving a customer application for a customer defined mobile commerce transaction account; and
determining customer approval status based on the customer application.

5. The method of claim 1 further comprising:
assigning a customer ID to a transponder device; and
providing a user interface and the transponder device to customers.

6. The method of claim 5 wherein the customer defined mobile commerce transaction account is edited by a customer through the user interface.

7. The method of claim 1 further comprising:
sending the transaction status to the transaction provider.

8. The method of claim 1 further comprising:
sending the transaction status to a HQ transaction server.

9. The method of claim 8 further comprising:
sending the transaction status to the transaction provider from the HQ transaction server.

10. The method of claim 1 wherein the customer defined mobile commerce transaction account is located on a web server.

11. The method of claim 1 wherein the customer defined mobile commerce transaction account is located on a transaction server.

12. The method of claim 1 wherein the customer defined mobile commerce transaction account corresponds to at least one customer ID.

13. A system for conducting user defined mobile commerce comprising:
means for receiving a customer ID and a transaction information from a transaction provider;
means for accessing a customer defined mobile commerce transaction account corresponding to the customer ID;
means for comparing at least a portion of the transaction information with the customer defined mobile commerce transaction account information; and
means for determining a transaction status based on the comparison of the transaction information and the customer defined mobile commerce transaction account information.

14. The system of claim 13 further comprising:
means for receiving a transaction provider application for a business mobile commerce transaction account; and
means for determining a transaction provider approval status based on the transaction provider application.

15. The system of claim 13 further comprising:
means for receiving a customer application for a customer defined mobile commerce transaction account; and
means for determining customer approval status based on the customer application.

16. The system of claim 13 further comprising:
means for assigning a customer ID associated with the customer defined mobile commerce transaction account, to a transponder device; and
means for providing a user interface for the customer defined mobile commerce transaction account.

17. The system of claim 16 further comprising:
means for the customer defined mobile commerce transaction account to be edited by a customer through the user interface.

18. A computer usable medium storing a computer program comprising:
computer readable code for receiving a customer ID and a transaction information from a transaction provider;
computer readable code for accessing a customer defined mobile commerce transaction account corresponding to the customer ID;
computer readable code for comparing at least a portion of the transaction information with the customer defined mobile commerce transaction account information; and
computer readable code for determining a transaction status based on the comparison of the transaction information and the customer defined mobile commerce transaction account information.

19. The computer readable medium of claim 18 further comprising:
computer readable code for receiving a transaction provider application for a business mobile commerce transaction account; and
computer readable code for determining a transaction provider approval status based on the transaction provider application.

20. The computer readable medium of claim 18 further comprising:
computer readable code for receiving a customer application for a customer defined mobile commerce transaction account; and
computer readable code for determining customer approval status based on the customer application.

21. The computer readable medium of claim 18 further comprising:
computer readable code for assigning a customer ID associated with the customer defined mobile commerce transaction account, to a transponder device; and
computer readable code for providing a user interface for the customer defined mobile commerce transaction account.

22. The computer readable medium of claim 21 further comprising:
computer readable code for allowing the customer defined mobile commerce transaction account to be edited by a customer through the user interface.
